(19) United States
(12) Patent Application Publication
(10) Pub. No.: US 2022/0369551 A1
(43) Pub. Date: Nov. 24, 2022

(54) WORK MACHINE

(71) Applicant: HONDA MOTOR CO., LTD., Minato-ku, Tokyo (JP)

(72) Inventors: Yuki Koike, Wako-shi, Saitama-ken (JP); Shingo Tsuruoka, Wako-shi, Saitama-ken (JP); Mai Kurihara, Wako-shi, Saitama-ken (JP); Takuma Namiki, Wako-shi, Saitama-ken (JP); Gaku Naoe, Wako-shi, Saitama-ken (JP)

(21) Appl. No.: 17/771,830

(22) PCT Filed: Oct. 31, 2019
(86) PCT No.: PCT/JP2019/042949

§ 371 Date: Apr. 26, 2022

(51) Int. Cl. A01D 34/90

(52) U.S. Cl. CPC A01D 34/90; A01D 34/416

(57) ABSTRACT

A work machine wherein motive power of a drive part is transmitted to an operation part through a shaft, the shaft being inserted into a cylindrical part and supported by a plurality of bearing members. In the cylindrical part, the plurality of bearing members are disposed on the node side of vibration generated in the shaft or the cylindrical part.

### TECHNICAL FIELD

The present invention relates to a work machine that transmits power of a drive unit to a working unit via a shaft supported by a plurality of bearing members inside a tubular portion.

### BACKGROUND ART

For example, JP S53-062627 A, JP H11-257335 A and JP 5297646 B2 disclose portable work machines. The portable work machine transmits power of a drive unit such as an internal combustion engine to a working unit such as a cutting blade via a shaft inserted into a tubular portion and supported by a plurality of bearing members.

### SUMMARY OF THE INVENTION

When the power of the drive unit is transmitted to the working unit via the shaft and the working unit performs predetermined work, the shaft, the plurality of bearing members, and the tubular portion integrally vibrate due to the vibration of the drive unit or the working unit serving as a vibration source. In this case, when the natural frequency of a structure formed of the shaft, the plurality of bearing members, and the tubular portion is close to the frequency of the vibration of the drive unit or the working unit, the vibration of the structure resonates and becomes larger. A handle gripped by an operator is connected to the outer peripheral surface of the tubular portion of the work machine via a handle support portion. Accordingly, the vibration of the structure is transmitted to the handle via the handle support portion.

The present invention has been made in consideration of the above problem, and an object thereof is to provide a work machine capable of reducing vibration of a shaft and a tubular portion.

According to an aspect of the present invention, provided is a work machine comprising: a drive unit; a working unit driven by power of the drive unit; a shaft configured to transmit the power of the drive unit to the working unit; a tubular portion which is disposed between the drive unit and the working unit, and in which the shaft is inserted; and a plurality of bearing members configured to support the shaft inside the tubular portion, wherein the plurality of bearing members are arranged inside the tubular portion, on a side of a node of vibration generated in the shaft or the tubular portion.

According to the present invention, it is possible to reduce the vibration transmissibility between the shaft and the tubular portion by arranging the plurality of bearing members on the node side of the vibration. As a result, it is possible to prevent the structure formed of the shaft, the plurality of bearing members, and the tubular portion from vibrating integrally. As a result, vibration of the shaft and the tubular portion can be reduced. That is, the shaft and the tubular portion vibrate in independent modes (bending vibration modes). Therefore, the frequency of the vibration generated in the shaft or the tubular portion can be shifted from the frequency of the vibration of the drive unit or the working unit serving as the vibration source. Accordingly, it is possible to suppress the occurrence of resonance in the shaft and the tubular portion.

### BRIEF DESCRIPTION OF DRAWINGS

FIG. 1 is a perspective view of a work machine according to a present embodiment;

FIG. 2 is a side view of the inside of the work machine of FIG. 1;

FIG. 3 is a cross-sectional view taken along line III-III of FIG. 2;

FIG. 4A is an explanatory view schematically illustrating the arrangement of bearing members and the occurrence of vibration in a comparative example, FIG. 4B is an explanatory view schematically illustrating the arrangement of bearing members in a first example, and FIG. 4C is an explanatory view schematically illustrating the arrangement of bearing members in a second example;

FIG. 5 is an explanatory view of vibration generated in the comparative example;

FIG. 6 is an explanatory view of vibration generated in the first example;

FIG. 7 is a diagram showing the relationship between the frequency and the vibration acceleration in the first example;

FIG. 8 is an explanatory view of vibration generated in the second example; and

FIG. 9 is an explanatory view of vibration generated in the second example.

### DESCRIPTION OF THE INVENTION

Hereinafter, a preferred embodiment of a work machine according to the present invention will be illustrated and described in an exemplary manner with reference to the accompanying drawings.

### 1. Schematic Configuration of Present Embodiment

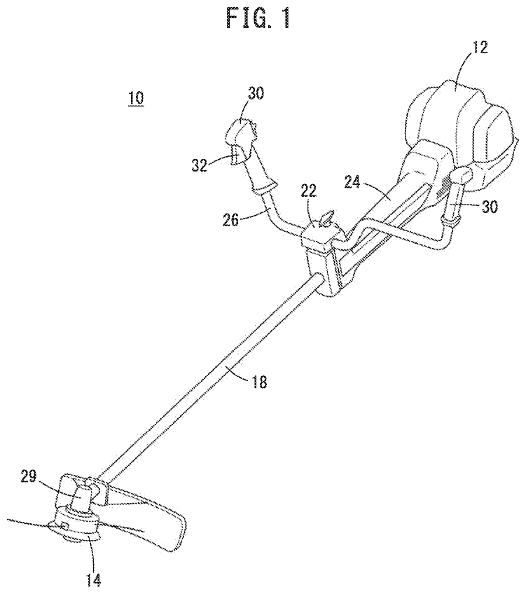

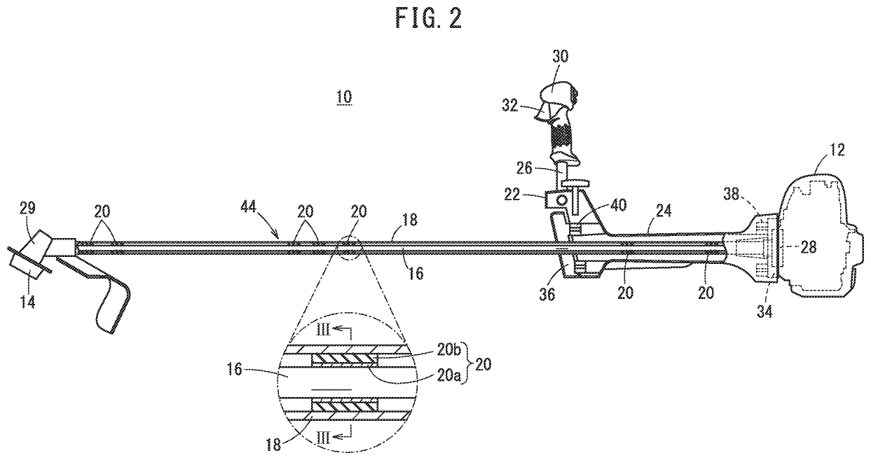

As shown in FIGS. 1 and 2, a work machine 10 according to the present embodiment is a brush cutter as a portable work machine, and includes a drive unit 12, a working unit 14 driven by the power of the drive unit 12, a shaft 16 that transmits the power of the drive unit 12 to the working unit 14, a tubular portion 18 which is disposed between the drive unit 12 and the working unit 14 and in which the shaft 16 is inserted, and a plurality of bearing members 20 that support the shaft 16 inside the tubular portion 18. A floating box 24 having a handle support portion 22 is provided on the outer peripheral surface of the tubular portion 18 on the drive unit 12 side. A handle 26 gripped by an operator is supported by the handle support portion 22.

The drive unit 12 is provided on the base end side of the shaft 16 and the tubular portion 18 and uses, for example, an internal combustion engine as a drive source thereof. The shaft 16 is, for example, a rod-shaped shaft made of steel, and has a base end connected to the drive source of the drive unit 12 via a clutch 28, and a distal end connected to the working unit 14 via a transmission gear 29. Power (rotational force) of the drive unit 12 is transmitted to the working unit 14 via the clutch 28, the shaft 16, and the transmission gear 29. Therefore, the drive unit 12 and the working unit 14 may vibrate at different frequencies due to the transmission gear 29. In addition, when the work machine 10 is actually used, the working unit 14 performs predetermined work at a frequency of about 120 Hz. The tubular portion 18 is, for example, an aluminum pipe, and has a base end connected to the drive unit 12, and a distal end connected to the working unit 14.

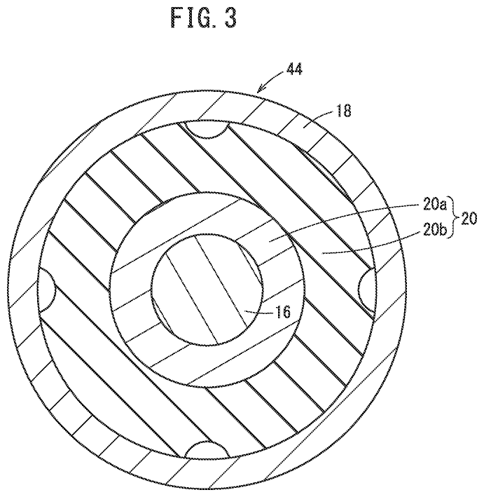

As shown in FIGS. 2 and 3, the plurality of bearing members 20 rotatably support the shaft 16 such that the shaft 16 and the tubular portion 18 are substantially coaxial with each other inside the tubular portion 18. Each of the bearing members 20 is formed of a bushing 20a and an elastic member 20b. The bushing 20a is made of a tubular metal member impregnated with oil, and is in contact with the outer peripheral surface of the shaft 16. The elastic member 20b is made of an oil-resistant tubular rubber member, and is disposed between the outer peripheral surface of the bushing 20a and the inner peripheral surface of the tubular portion 18. The arrangement positions of the plurality of bearing members 20 inside the tubular portion 18 will be described later.

The working unit 14 is, for example, a rotary cutting blade connected to the distal end of the shaft 16, and performs predetermined work by being driven by power (by being rotated by rotational force) transmitted from the drive unit 12 via the clutch 28 and the shaft 16. The handle 26 is provided with a pair of left and right grips 30 that are gripped by the operator during work. One grip 30 is provided with a throttle lever 32 that adjusts the power of the drive unit 12.

A first holding portion 34 is provided at the base end of the tubular portion 18. The first holding portion 34 is connected to the drive unit 12, and covers the clutch 28 and the base end of the tubular portion 18. In addition, a second holding portion 36 is provided at a location separated by a predetermined distance from the base end of the tubular portion 18 toward the working unit 14 along the longitudinal direction of the shaft 16. The second holding portion 36 surrounds the outer peripheral surface of the tubular portion 18. The floating box 24 is disposed on the base end side of the tubular portion 18 so as to be sandwiched between the first holding portion 34 and the second holding portion 36.

A base end of the floating box 24 is connected to the first holding portion 34 via a first vibration absorbing member 38. A distal end of the floating box 24 is connected to the second holding portion 36 via a second vibration absorbing member 40. The handle support portion 22 is attached to the distal end of the floating box 24 on the second holding portion 36 side. The first vibration absorbing member 38 and the second vibration absorbing member 40 are elastic bodies such as rubber, and are provided to suppress vibration transmitted from the base end side of the tubular portion 18 to the handle 26 via the handle support portion 22.

### 2. Characteristic Configuration of Present Embodiment

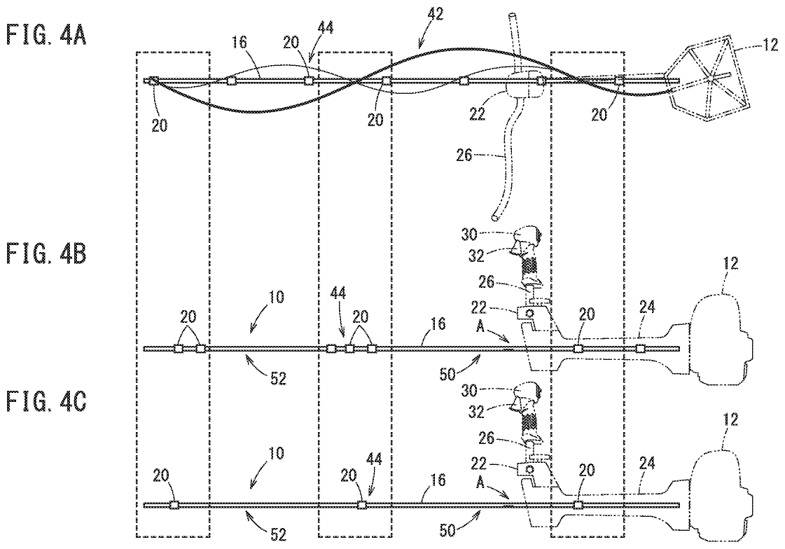

Next, a characteristic configuration of the work machine 10 according to the present embodiment will be described. The characteristic configuration relates to the arrangement of the plurality of bearing members 20 inside the tubular portion 18. FIG. 4A (comparative example) illustrates the arrangement of the plurality of bearing members 20 in a conventional work machine 42. FIG. 4B (first example) and FIG. 4C (second example) illustrate the arrangement of the plurality of bearing members 20 in the work machine 10 according to the present embodiment. In FIGS. 4A to 4C, the configurations of the work machines 10 and 42 are schematically illustrated in order to highlight the arrangement positions of the plurality of bearing members 20 with respect to the shaft 16. In the description of the comparative example and the first and second examples, the same constituent elements may be denoted by the same reference numerals.

In the comparative example, as shown in FIG. 4A, the plurality of bearing members 20 are arranged at equal intervals along the longitudinal direction of the shaft 16 inside the tubular portion 18 (see FIGS. 1 to 3). On the other hand, in the present embodiment, as shown in FIGS. 4B and 4C, the plurality of bearing members 20 are arranged at uneven intervals along the longitudinal direction of the shaft 16 inside the tubular portion 18. The reason for the arrangement at uneven intervals is as follows.

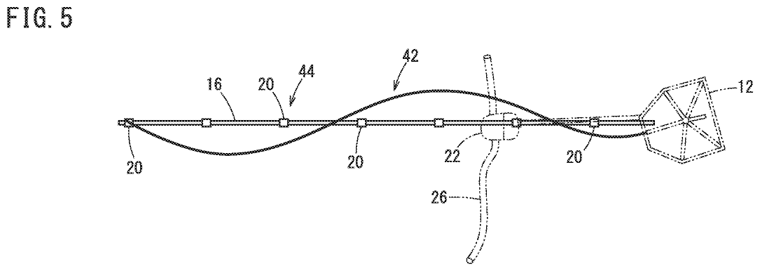

As shown in FIGS. 4A and 5, also in the comparative example, the shaft 16 and the tubular portion 18 (see FIGS. 1 to 3) are connected to each other via the plurality of bearing members 20. The base end of the shaft 16 is connected to the drive unit 12. The distal end of the shaft 16 is connected to the working unit 14 via the transmission gear 29. Therefore, when vibration is generated in the drive unit 12 or the working unit 14 serving as the vibration source, the shaft 16, the plurality of bearing members 20, and the tubular portion 18 integrally vibrate due to the vibration. In this case, if the natural frequency of a structure 44 formed of the shaft 16, the plurality of bearing members 20, and the tubular portion 18 is close to the frequency of the vibration of the drive unit 12 or the working unit 14, the vibration of the structure 44 resonates and becomes larger. The handle support portion 22 is disposed on the outer peripheral surface of the tubular portion 18 via the second holding portion 36 and the second vibration absorbing member 40, and the handle 26 is supported by the handle support portion 22. Therefore, in the case of the comparative example, the vibration of the resonating structure 44 is transmitted from the second holding portion 36 to the handle 26 via the second vibration absorbing member 40 and the handle support portion 22.

In FIGS. 4A and 5, when the frequency of vibration of the drive unit 12 or the working unit 14 and the natural frequency of the structure 44 are both 120 Hz, vibration generated in the structure 44 is schematically illustrated by a thick line. In addition, the thin line in FIG. 4A schematically illustrates a case where the shaft 16 vibrates alone.

As described above, in the comparative example, the mode of vibration (bending vibration mode) generated in the structure 44 is not considered at all, and the plurality of bearing members 20 are uniformly arranged along the longitudinal direction of the shaft 16. Therefore, for example, when any of the bearing members 20 is disposed at a position of the antinode of vibration, the resonating vibration is transmitted from the shaft 16 to the tubular portion 18 via the bearing member 20. As a result, larger vibration is transmitted to the handle 26.

Therefore, in the present embodiment, as shown in FIG. 4B (first example) and FIG. 4C (second example), the plurality of bearing members 20 are arranged on the node side of the vibration generated in the shaft 16 or the tubular portion 18. The node of vibration is a portion where vibration is small. Therefore, transmission of vibration between the shaft 16 and the tubular portion 18 is suppressed. That is, the plurality of bearing members 20 function as members that separate the vibration of the shaft 16 and the vibration of the tubular portion 18, and reduce the vibration transmissibility between the shaft 16 and the tubular portion 18. As a result, the shaft 16 and the tubular portion 18 vibrate in independent modes (bending vibration modes), whereby the occurrence of resonance is suppressed, and the structure 44 can be prevented from integrally vibrating.

Further, in the present embodiment, the natural frequency of the structure 44 can be changed to any frequency by unevenly arranging the plurality of bearing members 20 along the longitudinal direction of the shaft 16. Accordingly, the natural frequency of the structure 44 changes to a frequency range different from that of the frequency of the vibration of the drive unit 12 or the working unit 14. As a result, the occurrence of resonance in the structure 44 can be avoided.

Specifically, in the first example shown in FIG. 4B, two or three bearing members 20 are collectively arranged in the vicinity of each of a plurality of nodes of vibration in the structure 44, that is, in each of portions surrounded by broken lines in FIGS. 4A to 4C. In the first example, the plurality of bearing members 20 may be collectively arranged in the vicinity of each of the plurality of nodes. Further, in the second example shown in FIG. 4C, a case where one bearing member 20 is disposed in the vicinity of each of the plurality of nodes of vibration in the structure 44 is illustrated.

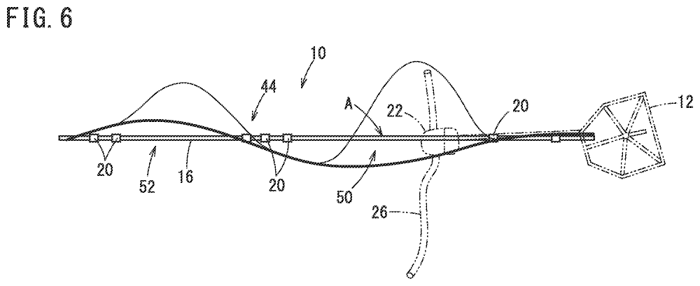

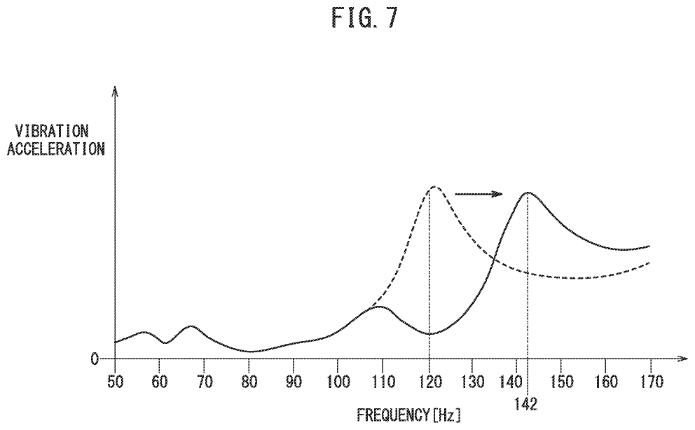

FIGS. 6 and 7 show the results of the first example. In FIG. 7, the solid line indicates a change in vibration acceleration with respect to the frequency in the first example. The broken line indicates a change in vibration acceleration with respect to the frequency in the comparative example.

In FIGS. 6 and 7, the frequency of the vibration of the drive unit 12 or the working unit 14 is set to 120 Hz, and the natural frequency of the structure 44 is set to 142 Hz. That is, in the first example, the natural frequency of the structure 44 is shifted from 120 Hz to 142 Hz. Thus, the frequency of the vibration of the drive unit 12 or the working unit 14 is shifted from the natural frequency of the structure 44, and as a result, the vibration acceleration of the tubular portion 18 around 120 Hz is suppressed, and the vibration acceleration of the handle 26 is also suppressed.

Further, in the first example, the plurality of bearing members 20 are arranged on the node side of the vibration. Thus, the vibration transmissibility between the shaft 16 and the tubular portion 18 is reduced, and as a result, the vibration transmitted to the handle 26 can be suitably reduced.

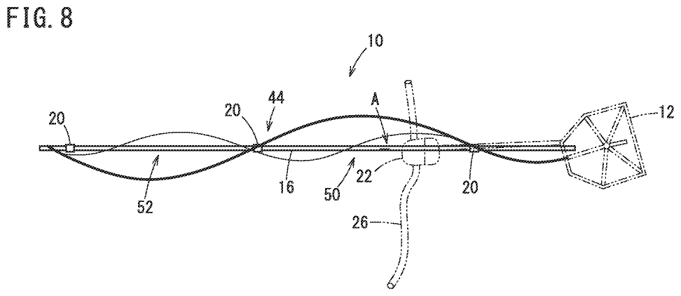

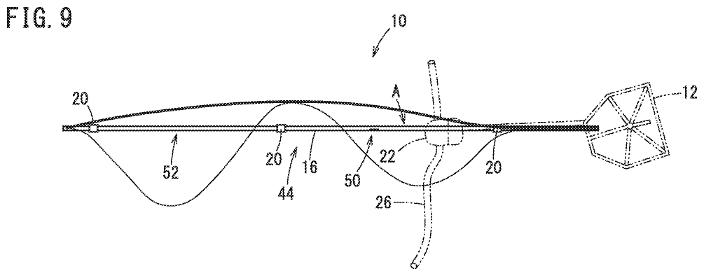

FIGS. 8 and 9 show the results of the second example. In FIG. 8, the frequency of the vibration of the drive unit 12 or the working unit 14 is set to 120 Hz, and the natural frequency of the structure 44 is set to 140 Hz. Further, in FIG. 9, the frequency of the vibration of the drive unit 12 or the working unit 14 is set to 120 Hz, and the natural frequency of the structure 44 is set to 99 Hz.

In the second example, the arrangement interval between the plurality of bearing members 20 is greatly widened as compared with the interval in the uniform arrangement in FIG. 4A. Accordingly, the natural frequency of the structure 44 is shifted from the frequency of the vibration of the drive unit 12 or the working unit 14, and as a result, the shaft 16 and the tubular portion 18 vibrate in independent modes. Therefore, in the second example as well, the occurrence of resonance can be suppressed as in the first example. Further, the vibration transmissibility between the shaft 16 and the tubular portion 18 can be reduced. As a result, the vibration transmitted to the handle 26 can be suitably reduced.

### 3. Effect of Present Embodiment

As described above, the work machine 10 according to the present embodiment includes the drive unit 12, the working unit 14 driven by the power of the drive unit 12, the shaft 16 that transmits the power of the drive unit 12 to the working unit 14, the tubular portion 18 which is disposed between the drive unit 12 and the working unit 14 and in which the shaft 16 is inserted, and the plurality of bearing members 20 that support the shaft 16 inside the tubular portion 18. In this case, the plurality of bearing members 20 are arranged inside the tubular portion 18 on the node side of the vibration generated in the shaft 16 or the tubular portion 18.

By arranging the plurality of bearing members 20 on the node side of the vibration in this manner, the vibration transmissibility between the shaft 16 and the tubular portion 18 can be reduced. Accordingly, it is possible to prevent the structure 44 formed of the shaft 16, the plurality of bearing members 20, and the tubular portion 18 from integrally vibrating. As a result, the vibration of the shaft 16 and the tubular portion 18 can be reduced. That is, the shaft 16 and the tubular portion 18 vibrate in independent modes (bending vibration modes), whereby it is possible to shift the frequency of the vibration generated in the shaft 16 or the tubular portion 18 from the frequency of the vibration of the drive unit 12 or the working unit 14 serving as the vibration source. Accordingly, it is possible to suppress the occurrence of resonance in the shaft 16 and the tubular portion 18.

In this case, the plurality of bearing members 20 are densely arranged in the vicinity of the node. In the shaft 16, a portion between two nodes is a portion that can freely vibrate (a free length portion that is an antinode portion). Therefore, by densely arranging the bearing members 20 in each of the two nodes, the load applied to each bearing member 20 is reduced. As a result, it is possible to suppress deterioration of the bearing members 20 while suppressing vibration displacement of the free length portion.

In addition, three bearing members 20 may be collectively arranged in the vicinity of at least one node among a plurality of nodes of the vibration. In this case, it is possible to suppress the occurrence of an antinode of vibration in the portion in which the bearing members 20 are collectively arranged. As a result, it is possible to control the order of the bending vibration mode of the shaft 16 while suppressing deterioration of the bearing members 20. For example, an antinode of vibration does not occur in a portion in which three bearing members 20 are collectively arranged, and the shaft 16 and the tubular portion 18 independently and freely vibrate in a free length portion in which an interval between the bearing members 20 is wide. In this manner, the order of the bending vibration mode of the shaft 16 can be controlled by appropriately adjusting the arrangement interval between the portion in which the bearing members 20 are collectively arranged and the free length portion. In addition, it is possible to adjust the shift amount of the natural frequency of the structure 44.

In addition, the work machine 10 is a portable work machine further including the handle support portion 22 connected to the outer peripheral surface of the tubular portion 18, and the handle 26 supported by the handle support portion 22 and gripped by the operator. As described above, since the transmission of vibration to the handle 26 is suppressed, the marketability of the work machine 10 can be improved.

Further, in the present embodiment, by utilizing CAE (Computer Aided Engineering) analysis, it is possible to examine the optimum arrangement of the plurality of bearing members 20 while confirming the bending vibration mode and the resonance frequency. In addition, by appropriately adjusting parameters such as a basic skeleton, a weight, and an inertial mass of each part of the work machine 10, it is possible to examine optimization of the arrangement of the bearing members 20 in any type of work machine. When the CAE analysis is used, the optimum arrangement of the bearing members 20 is specified by short-time analysis with respect to the pattern of one work machine 10. As a result, the number of examination steps can be greatly reduced as compared with the examination on an experimental basis.

### 4. Other Configurations, etc.

In the work machine 10 according to the present embodiment, the plurality of bearing members 20 are arranged at uneven intervals along the longitudinal direction of the shaft 16 inside the tubular portion 18. Specifically, a portion of the shaft 16 that faces the second holding portion 36, that is, a portion of the shaft 16 onto which the second holding portion 36 is projected is defined as a region A, and the region A is made to correspond to an antinode of vibration generated in the shaft 16. Then, the plurality of bearing members 20 are arranged inside the tubular portion 18, at locations other than the region A along the longitudinal direction of the shaft 16. Specifically, among the plurality of bearing members 20, two bearing members 20 are arranged on both sides of the region A along the longitudinal direction of the shaft 16. A region including the region A and extending along the longitudinal direction of the shaft 16 so as to correspond to the interval between the two bearing members 20 (a region of the shaft 16 sandwiched between the two bearing members 20) is defined as a first region 50. That is, the two bearing members 20 are arranged outside the first region 50 (region A) extending along the longitudinal direction of the shaft 16 so as to sandwich the first region 50 at an interval wider than the first region 50.

Since the antinode of the vibration is a portion where the vibration is large, the first region 50 is set as an antinode portion that freely vibrates independently of the tubular portion 18. Accordingly, when vibration is generated in the shaft 16 due to vibration of the drive unit 12 or the working unit 14, excitation energy caused by the vibration of the drive unit 12 or the working unit 14 flows to the first region 50, and the first region 50 largely vibrates by the excitation energy. Therefore, it is possible to prevent the excitation energy from flowing to the tubular portion 18 via the plurality of bearing members 20. As a result, vibration of the tubular portion 18 is suppressed, and the vibration transmitted to the handle 26 via the handle support portion 22 is reduced.

The interval between the two bearing members 20 arranged at both ends of the first region 50 is set to a length corresponding to the frequency of the vibration generated in the shaft 16. Accordingly, for example, when the interval between the two bearing members 20 is set to a length corresponding to the frequency of the vibration of the working unit 14, the excitation energy caused by the vibration of the working unit 14 flows to the first region 50, and the first region 50 largely vibrates by the excitation energy.

Further, in the present embodiment, a second region 52 may be provided in the shaft 16 separately from the first region 50. In this case, the second region 52 is made to correspond to an antinode of vibration having a frequency different from the frequency of the vibration corresponding to the first region 50. Then, among the plurality of bearing members 20, two bearing members 20 are arranged in the vicinity of both ends of the second region 52.

The second region 52 is set as an antinode portion that freely vibrates independently of the tubular portion 18. Accordingly, when vibration is generated in the shaft 16 due to vibration of the drive unit 12 or the working unit 14, excitation energy caused by the vibration of the drive unit 12 or the working unit 14 flows to the second region 52, and the second region 52 largely vibrates by the excitation energy. Also in this case, it is possible to prevent the excitation energy from flowing to the tubular portion 18 via the plurality of bearing members 20, and prevent the tubular portion 18 from vibrating. As a result, vibration transmitted to the handle 26 via the second holding portion 36, the second vibration absorbing member 40, and the handle support portion 22 can be reduced.

Further, the interval between the two bearing members 20 corresponds to the length of the second region 52. In this case, for example, if the interval between the two bearing members 20 is set to a length corresponding to the frequency of the vibration of the drive unit 12, the excitation energy caused by the vibration of the drive unit 12 flows to the second region 52, and the second region 52 largely vibrates by the excitation energy.

The present embodiment is not limited to the case where two regions, namely, the first region 50 and the second region 52 are formed in one shaft 16, and at least one of the first region 50 or the second region 52 may be formed in one shaft 16.

As described above, by appropriately adjusting the interval between the two bearing members 20 in the vicinity of both ends of the first region 50 in accordance with the frequency of vibration to be reduced, the first region 50 can be vibrated independently of the tubular portion 18 and in synchronization with the vibration frequency of the working unit 14. Consequently, since the excitation energy caused by the vibration of the working unit 14 flows to the first region 50, the vibration of the tubular portion 18 at the position of the second holding portion 36 (response point) is suppressed. As a result, the vibration transmitted to the handle 26 can be reduced. Therefore, by using the method of the present embodiment, it is possible to optimize vibration reduction. For example, even when the design of the reduction ratio of the transmission gear 29 for driving the working unit 14 is altered and the vibration frequency of the working unit 14 is changed, the vibration reduction can be optimized by appropriately adjusting the interval between the two bearing members 20 in the vicinity of both ends of the first region 50.

More specifically, in the above-described method, vibration is reduced by effectively utilizing an antiresonance phenomenon (antiresonance frequency). Here, the antiresonance frequency refers to a frequency at which vibration existing between adjacent resonance frequencies has a minimum value at a certain response point (the position of the second holding portion 36).

Specifically, by adjusting the arrangement of the plurality of bearing members 20, the shaft 16 and the tubular portion 18 resonate on the low frequency side and the high frequency side with a predetermined excitation frequency interposed therebetween. That is, resonances at two natural frequencies occur separately. In this case, the shaft 16 and the tubular portion 18 are changed in the same phase on one of the low frequency side or the high frequency side, and the shaft 16 and the tubular portion 18 are changed in opposite phases on the other of the low frequency side and the high frequency side.

Therefore, the natural frequency is separated into two natural frequencies on the low frequency side and the high frequency side, and the phase of the tubular portion 18 is inverted to the phase of the shaft 16 on the other side. As a result, antiresonance can be generated at the excitation frequency with respect to the displacement of the vibration of the tubular portion 18. That is, it is possible to generate a frequency range in which the displacement of the vibration has the minimum value, between the two separated natural frequencies.

In this manner, by setting the natural frequency of the first region 50 in the frequency range in which the vibration is minimized, it is possible to effectively reduce the vibration with respect to the excitation frequency of the working unit 14 of, for example, 120 Hz. For other natural frequencies, the vibration can be reduced based on the same principle.

It should be noted that, as exemplified by the second region 52, when the region in which the shaft 16 vibrates independently of the tubular portion 18 is provided at a location shifted from the response point (the position of the second holding portion 36 in the tubular portion 18) at which vibration is to be reduced, a shift occurs between the natural frequency of the second region 52 determined based on the interval between the two bearing members 20, and the frequency range in which vibration is most reduced at the response point. In this case, the optimum arrangement of the bearing members 20 for reducing vibration may be examined while confirming the frequency response at the response point by utilizing CAE analysis or the like.

In addition, in a case where the interval between the two bearing members 20 is changed in accordance with the frequency of the vibration to be reduced, it is possible to suppress an influence on a low frequency region equal to or lower than the frequency of this vibration to be reduced. This is because the effect of separating the vibration modes of the tubular portion 18 and the shaft 16 due to the arrangement adjustment of the bearing members 20 remarkably appears in third or higher order bending modes of the tubular portion 18, and therefore, the effect of separating the vibration modes of the tubular portion 18 and the shaft 16 is small in a low frequency region where the order of bending is low, even if the arrangement adjustment of the bearing members 20 is performed. Therefore, in the present embodiment, it is possible to reduce the vibration at the frequency to be reduced, in the high frequency range in which the use frequency is high in practice, without affecting the frequency range of other practical rotation speed ranges.

It should be noted that the present invention is not limited to the embodiment described above, and it goes without saying that various configurations could be adopted therein on the basis of the descriptive content of the present specification.

What is claim is:

1. A work machine comprising:
a drive unit;
a working unit driven by power of the drive unit;
a shaft configured to transmit the power of the drive unit to the working unit;
a tubular portion which is disposed between the drive unit and the working unit, and in which the shaft is inserted; and
a plurality of bearing members configured to support the shaft inside the tubular portion, wherein
the plurality of bearing members are arranged inside the tubular portion, on a side of a node of vibration generated in the shaft or the tubular portion.

2. The work machine according to claim 1, wherein
the plurality of bearing members are densely arranged in a vicinity of the node.

3. The work machine according to claim 2, wherein
three of the bearing members are collectively arranged in a vicinity of at least one node among a plurality of the nodes of the vibration.

4. The work machine according to claim 1, wherein
the work machine is a portable work machine further comprising a handle support portion connected to an outer peripheral surface of the tubular portion, and a handle supported by the handle support portion and gripped by an operator.
